(19) United States
(12) Patent Application Publication
(10) Pub. No.: US 2025/0307734 A1
(43) Pub. Date: Oct. 2, 2025

(54) ENVIRONMENTAL SURVEY MATCHING APPARATUS, ENVIRONMENTAL SURVEY MATCHING METHOD, AND NON-TRANSITORY COMPUTER READABLE MEDIUM

(71) Applicant: NEC Corporation, Tokyo (JP)

(72) Inventors: Kenichi UEDA, Tokyo (JP); Shuhei KUMATANI, Tokyo (JP); Haruki MIZUTANI, Tokyo (JP); Shinnosuke NISHIMOTO, Tokyo (JP)

(73) Assignee: NEC Corporation, Tokyo (JP)

(21) Appl. No.: 19/081,133

(22) Filed: Mar. 17, 2025

(30) Foreign Application Priority Data
Mar. 26, 2024 (JP) 2024-049143

(51) Int. Cl. G06Q 10/0631

(52) U.S. Cl. CPC G06Q 10/063112

(57) ABSTRACT

An environmental survey matching apparatus capable of quickly and efficiently collecting environmental data is provided. In an environmental survey matching apparatus according to the present disclosure, a survey request receiving unit receives an environmental survey request from a user. A surveyor selecting unit selects a surveyor suitable for the environmental survey request based on a result of matching between a factor included in the environmental survey request and a factor included in data on a surveyor stored in advance. A surveying means selecting unit selects surveying means including at least one of an apparatus and a tool suitable for the environmental survey request. A survey instruction unit supplies a survey instruction including a list of the selected surveying means to the selected surveyor

### INCORPORATION BY REFERENCE

This application is based upon and claims the benefit of priority from Japanese patent application No. 2024-049143, filed on Mar. 26, 2024, the disclosure of which is incorporated herein in its entirety by reference.

### TECHNICAL FIELD

The present disclosure relates to an environmental survey matching apparatus, an environmental survey matching method, and a non-transitory computer readable medium.

### BACKGROUND ART

Patent Literature 1 discloses a technology for surveying an environment, in which environmental data such as data on environmental pollution situations of soil, groundwater, and the like is collected from users, and the collected environmental data is evaluated.
Patent Literature 1: Japanese Unexamined Patent Application Publication No. 2002-168850

In recent years, users in companies and research institutes have faced a serious problem that since environments are changing over a wide range and the need for various data points is increasing, there is not enough environmental data, which are primary data. Further, due to the lack of environmental data, it is also difficult for such users to obtain specific environmental data required. Further, in recent years, when such users disclose information, they are required to provide data on impacts on environments. Therefore, such users need to quickly acquire appropriate environmental data in order to comply with changing regulations for the disclosure of sustainability-related information.

However, the technology disclosed in Patent Literature 1 has a problem that it is not possible to quickly and efficiently collect environmental data. Specifically, in environmental surveys, the mainstream process is to send a surveyor(s) such as a researcher(s) and an expert(s) to a specific place which it is desired to survey, and then the surveyor(s) collect data at that place. This surveying process involves the use of various apparatuses and tools such as sensors and measuring devices. Each of these apparatuses and tools is often used by itself and is often used for the purpose of a specific environmental survey. Further, the collection of data requires high-level expert knowledge and is often manually carried out, so it is time-consuming. As a result, there is a limit on the acquisition of data, and in particular, it is difficult to acquire environmental data covering a wide area or in a remote area.

### SUMMARY

In view of the above-described problems, an object of the present disclosure is to provide an environmental survey matching apparatus, an environmental survey matching method, and a non-transitory computer readable medium capable of quickly and efficiently collecting environmental data.

An environmental survey matching apparatus according to an aspect of the present disclosure includes:
a survey request receiving unit configured to receive an environmental survey request from a user;
a surveyor selecting unit configured to select a surveyor suitable for (i.e., a surveyor who meets the requirements of) the environmental survey request based on a result of matching between a factor included in the environmental survey request and a factor included in data on a surveyor stored in advance;
a surveying means selecting unit configured to select surveying means including at least one of an apparatus and a tool suitable for (i.e., a tool which meets the requirements of) the environmental survey request; and
a survey instruction unit configured to supply a survey instruction including a list of the selected surveying means to the selected surveyor.

In an environmental survey matching method, a computer:
receives an environmental survey request from a user;
selects a surveyor suitable for the environmental survey request based on a result of matching between a factor included in the environmental survey request and a factor included in data on a surveyor stored in advance;
selects surveying means including at least one of an apparatus and a tool suitable for the environmental survey request; and
supplies a survey instruction including a list of the selected surveying means to the selected surveyor.

A non-transitory computer readable medium according to an aspect of the present disclosure stores a program for causing a computer to perform processes including:
receiving an environmental survey request from a user;
selecting a surveyor suitable for the environmental survey request based on a result of matching between a factor included in the environmental survey request and a factor included in data on a surveyor stored in advance;
selecting surveying means including at least one of an apparatus and a tool suitable for the environmental survey request; and
supplying a survey instruction including a list of the selected surveying means to the selected surveyor.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a block diagram showing an example of a configuration of an environmental survey matching apparatus 10 according to an example embodiment;

FIG. 2 is a block diagram showing an example of a configuration of an environmental survey matching system 2 according to an example embodiment;

FIG. 3 is a flowchart showing an example of operations performed by an environmental survey matching apparatus 20 according to an example embodiment;

FIG. 4 shows an example of a window for registering an environmental survey request displayed on a user terminal 101 of the environmental survey matching system 2 according to an example embodiment;

FIG. 5 shows an example of a window for registering surveyor data displayed on a surveyor terminal 102 of the environmental survey matching system 2 according to an example embodiment; and

FIG. 6 is a block diagram showing an example of a hardware configuration of a computer 1000 according to an example embodiment.

### EXAMPLE EMBODIMENT

An example embodiment according to the present disclosure will be described hereinafter in detail with reference to the drawings. The same or corresponding factors are assigned the same reference numerals (or symbols), and redundant descriptions thereof are omitted as appropriate to clarify the explanation.

### First Example Embodiment

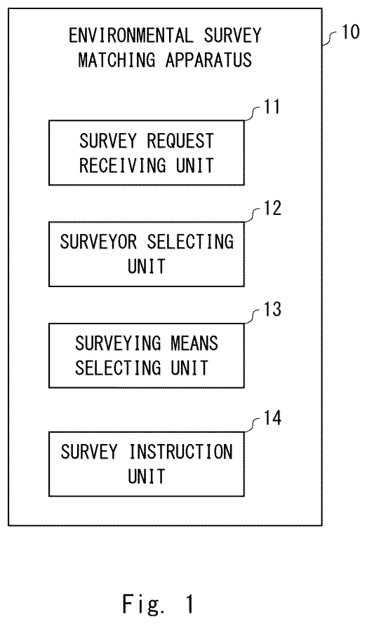

Firstly, a configuration of an environmental survey matching apparatus 10 according to a first example embodiment will be described with reference to FIG. 1.

FIG. 1 is a block diagram showing an example of a configuration of the environmental survey matching apparatus 10 according to this example embodiment. As shown in FIG. 1, the environmental survey matching apparatus 10 includes a survey request receiving unit 11, a surveyor selecting unit 12, a surveying means selecting unit 13, and a survey instruction unit 14.

The survey request receiving unit 11 receives an environmental survey request from a user. The surveyor selecting unit 12 selects a surveyor suitable for the environmental survey request based on the result of matching between a factor(s) included in the environmental survey request and a factor(s) included in data on a surveyor stored in advance. The surveying means selecting unit 13 selects surveying means including at least one of an apparatus and a tool suitable for the environmental survey request. The survey instruction unit 14 supplies a survey instruction including a list of the selected surveying means to the selected surveyor.

The environmental survey matching apparatus 10 can quickly and efficiently collect environmental data by selecting an appropriate surveyor and appropriate surveying means according to an environmental survey request.

### Second Example Embodiment

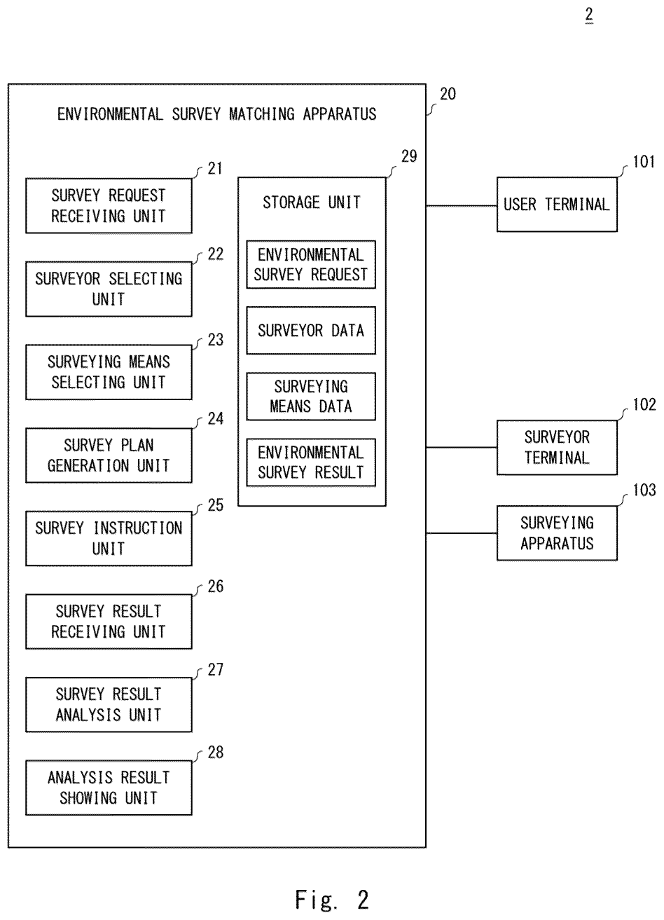

Next, a configuration of an environmental survey matching system 2 according to a second example embodiment will be described with reference to FIG. 2. The environmental survey matching system 2 is a specific example of the environmental survey matching apparatus 10 according to the first example embodiment.

FIG. 2 is a block diagram showing an example of the configuration of the environmental survey matching system 2 according to this example embodiment. As shown in FIG. 2, the environmental survey matching system 2 includes an environmental survey matching apparatus 20, a user terminal 101, a surveyor terminal 102, and a surveying apparatus 103.

The environmental survey matching apparatus 20 is, for example, a server constructed on a cloud system or the like. The environmental survey matching apparatus 20 communicates with the user terminal 101, the surveyor terminal 102, and the surveying apparatus 103 through a network. The network includes a LAN (Local Area Network), a WAN (Wide Area Network), the Internet, and the like.

The user terminal 101 is, for example, a terminal such as a tablet computer, a smartphone, or a PC (Personal Computer). The user terminal 101 is a terminal used by a user of a company, an organization, a research institution, or the like which requests an environmental survey. The user terminal 101 serves as a web-based or app-based interface through which the user interacts with the environmental survey matching apparatus 20.

The surveyor terminal 102 is a terminal such as a tablet computer, a smartphone, or a PC (Personal Computer). The surveyor terminal 102 is a terminal used by a surveyor who carries out an environmental survey. The surveyor terminal 102 serves as a web-based or app-based interface through which the surveyor interacts with the environmental survey matching apparatus 20.

The surveying apparatus 103 is an apparatus used by the surveyor when he/she conducts an environmental survey. The surveying apparatus 103 is, for example, a sensor, a drone, or a bio-logging device.

Specifically, the environmental survey matching apparatus 20 includes a survey request receiving unit 21, a surveyor selecting unit 22, a surveying means selecting unit 23, a survey plan generation unit 24, a survey instruction unit 25, a survey result receiving unit 26, a survey result analysis unit 27, an analysis result showing unit 28, and a storage unit 29.

An environmental survey request is stored in advance in the storage unit 29. The environmental survey request is a request that is received from a user for the purpose of collecting specific environmental data. The environmental survey request includes, as factors, a person or an entity which has requested a survey, the purpose of the survey, and the location of the survey. Further, the environmental survey request includes, as a factor(s), at least one of the urgency of the survey, an apparatus necessary for the survey, and the period of the survey. The environmental survey request is registered in the storage unit 29 by the user terminal 101. Note that the factors of the environmental survey request are not limited to the above-described factors, but may include other factors such as a necessary environmental survey result and a special requirement.

Further, surveyor data is also stored in advance in the storage unit 29. The surveyor data includes, as factors, the skill of the surveyor (specialty and/or qualification) and a geographical position where the surveyor is present (hereinafter also referred to as the geographical position of the surveyor). Further, the surveyor data includes, as a factor(s), at least one of the experience of the surveyor (years of experience and number of past projects) and the performance rating of the surveyor. Note that the specialty means the field of the specialty of the surveyor, such as a water-quality analysis and air-pollution measurement. The qualification includes an official certification for the use of a specific apparatus or a tool for the environmental survey. The years of experience mean years of experience in past projects. The number of past projects means the number of projects of environmental surveys which the surveyor has participated in in the past. The geographical position means the area which the surveyor is in charge of. The performance rating means the rating of the surveyor in regard to the efficiency, the accuracy, and the like when the surveyor participated in past projects. The surveyor data is registered in the storage unit 29 by the surveyor terminal 102. Note that the factors of the surveyor data are not limited to the above-described factors, and may include other factors such as an apparatus or a tool that the surveyor can use.

Further, surveying means data is also stored in advance in the storage unit 29. The surveying means data is data on features of surveying means including at least one of an apparatus and a tool. The features of the surveying means are, for example, the appropriateness of the surveying means to the environmental survey, the data collection accuracy of the surveying means, and the data collection range of the surveying means.

The survey request receiving unit 21 receives an environmental survey request from the storage unit 29. Note that the survey request receiving unit 21 may receive an environmental survey request directly from the user terminal 101.

The surveyor selecting unit 22 selects a surveyor suitable for the environmental survey request based on the result of matching between a factor(s) included in the environmental survey request with a factor(s) included in data on the surveyor stored in the storage unit 29. Specifically, the surveyor selecting unit 12 selects a surveyor suitable for the environmental survey request based on the result of matching between the purpose of the environmental survey with the skill of the surveyor, and the result of matching between the location of the environmental survey with the geographical position of the surveyor. Further, the surveyor selecting unit 12 may select a surveyor suitable for the environmental survey request by taking at least one of the experience of the surveyor and the performance rating of the surveyor into consideration. Further, the surveyor selecting unit 22 may calculate the importance of each of the factors included in the environmental survey request based on disclosed information, and dynamically change weighting in the matching based on the calculated importance. Further, when a plurality of surveyors are required for a specific environmental survey request, the surveyor selecting unit 22 may select the plurality of surveyors in an optimum combination by taking the balance of the entire team into consideration. Note that the surveyor selecting unit 12 uses at least one of a machine learning algorithm and a combinational optimization algorithm in the above-described matching.

The surveying means selecting unit 23 selects surveying means suitable for the environmental survey request. Specifically, the surveying means selecting unit 23 selects surveying means suitable for the environmental survey request based on the purpose and location of the environmental survey included in the environmental survey request and the features of the surveying means included in the surveying means data stored in the storage unit 29. The surveying means selecting unit 23 generates a list of selected surveying means.

The survey plan generation unit 24 generates an environmental surveying plan which is a plan of an environmental survey that the selected surveyor will carry out based on the environmental survey request. The environmental surveying plan includes at least one of a method for using the selected surveying means, a timing of data collection, a frequency of data collection, data collection points, and a procedure for uploading collected data.

The survey instruction unit 25 supplies a survey instruction including the list of selected surveying means and the generated environmental surveying plan to the surveyor terminal 102.

After the survey instruction is supplied to the surveyor, the survey result receiving unit 26 receives the result of the environmental survey (hereinafter also referred to as the environmental survey result) from at least one of the surveyor terminal 102 and the surveying apparatus 103. In this process, the survey result receiving unit 26 may accumulate the environmental survey result in the storage unit 29.

The survey result analysis unit 27 analyzes the received environmental survey result.

The analysis result showing unit 28 shows the result of the analysis in the user terminal 101 of the user who has made the environmental survey request.

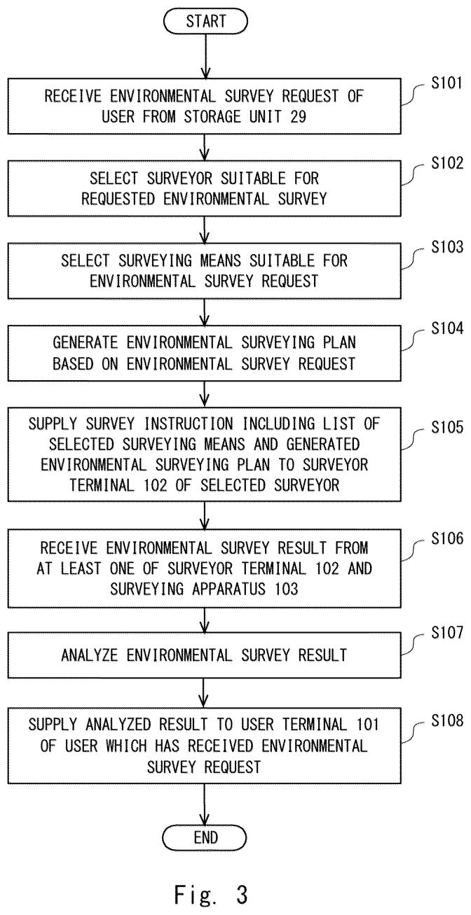

Next, operations performed by the environmental survey matching system 2 according to the second example embodiment will be described with reference to FIG. 3. FIG. 3 is a flowchart showing an example of operations performed by the environmental survey matching system 2 according to this example embodiment.

As shown in FIG. 3, firstly, in a step S101, the survey request receiving unit 21 of the environmental survey matching apparatus 20 receives an environmental survey request of a user from the storage unit 29. Note that the survey request receiving unit 21 may receive the environmental survey request directly from the user terminal 101.

The environmental survey request is a request that is received from a user for the purpose of collecting specific environmental data. The environmental survey request includes a person or an entity which has requested a survey (hereinafter also referred to as the request source of a survey), the purpose of the survey, and the location of the survey. Further, the environmental survey request includes at least one of the urgency of the survey, an apparatus(es) necessary for the survey, and the period of the survey.

Table 1 shows examples of environmental survey requests in the environmental survey matching system 2 according to this example embodiment.

TABLE 1

| Request | Request | | | | Necessary | Period |
|---|---|---|---|---|---|---|
| ID | Source | Purpose | Location | Urgency | Apparatus | (days) |
| 101 | EcoCorp | Water-quality | Lake | High | pH meter | 30 |
| | | survey | Biwa | | Water sampler | |
| 102 | GreenTech | Climate change | Hokkaido | Intermediate | Temperature sensor | 45 |
| | | impact analysis | | | Humidity sensor | |
| 103 | BioSolutions | Wildlife | Tropical | Low | Camera trap, GPS | 60 |
| | | survey | forest in | | tracking apparatus | |
| | | | Okinawa | | | |
| 104 | RiverClean | River | Tama | Intermediate | Water-quality | 20 |
| | | ecosystem | River | | analysis kit, | |
| | | analysis | | | Biological | |
| | | | | | Sampling apparatus | |

Data on a plurality of environmental survey requests are recorded in the table shown in Table 1. A unique “Request ID” is assigned to each environmental survey request. In the table, as its items, data on “Request Source” of the survey (i.e., a person or an entity which has requested the survey), “Purpose” of the survey, “Location” of the survey, “Urgency” of the survey, “Necessary Apparatus” for the survey”, and “Period (days)” of the survey are recorded. For example, an environmental survey request having a request ID “101” indicates a request from EcoCorp company. This request is a water-quality survey in Lake Biwa, Japan. The urgency of this request is high, and a pH meter and a water sampler are necessary for this request. The period of this survey is 30 days. Note that the period of the survey may be specified as, for example, From Feb. 1, 2024 to Feb. 30, 2024.

This request clarifies the specific requirements for the environmental survey and helps to select a surveyor(s) having resources and expert knowledge suitable for the requested environmental survey.

Next, in a step S102, the surveyor selecting unit 22 refers to surveyor data stored in the storage unit 29 and automatically selects a surveyor(s) suitable for the requested environmental survey from among candidate surveyors.

Specifically, the surveyor data includes the skill (specialty and/or qualification) of the surveyor and the geographical position of the surveyor. Further, the surveyor data includes information about at least one of the experience of the surveyor (years of experience and the number of past projects) and the performance rating of the surveyor.

Table 2 shows an example of surveyor data in the environmental survey matching system 2 according to this example embodiment.

TABLE 2

| | | | | | Number | | |
|---|---|---|---|---|---|---|---|
| Survey | | | | Years of | of Past | Geographical | Performance |
| or ID | Name | Specialty | Qualification | Experience | Projects | Position | Rating |
| 1 | Taro | Water | Water-Quality | 5 years | 20 | Tokyo | 4.5 |
| | Tanaka | Quality | Analyst | | | | |
| 2 | Hanako | Air- | Environmental | 3 years | 15 | Osaka | 4.2 |
| | Suzuki | Pollution | Measurement | | | | |
| | | Measurement | Engineer | | | | |
| 3 | Jiro | Biodiversity | Doctor of | 8 years | 30 | Sapporo | 4.7 |
| | Sato | | ecology | | | | |

Surveyor data is recorded in the table shown in Table 2. In this table, a unique “Surveyor ID” is assigned to each surveyor data. In the table, “Name”, “Specialty”, “Qualification”, “Years of Experience”, “Number of Past Projects”, “Geographical Position”, and “Performance Rating” of the surveyor are recorded. For example, the name of a surveyor having a surveyor ID “1” is “Taro Tanaka”. The specialty of the surveyor is “water-quality analysis”. The qualification of the surveyor is “water-quality analyst”. Years of experience of the surveyor is “5 years”. The number of past projects of the surveyor is “20”. The geographical position of the surveyor, i.e., the location where the surveyor is present, is “Tokyo”. The performance rating of the surveyor is “4.5”.

The surveyor data is useful to understand the capability and availability of a surveyor in detail and to assign a surveyor to an appropriate environmental survey. For example, when there is a project for an environmental survey in which water quality needs to be analyzed in Tokyo, the surveyor “Taro Tanaka” is selected as a candidate for the project.

The surveyor selecting unit 22 obtains optimal matching by combining at least one factor selected from the purpose, location, urgency, necessary apparatus, and period (days) included in the environmental survey request with at least one factor selected from the specialty, qualification, years of experience, number of past projects, geographical position, and performance rating of the surveyor included in the surveyor data. When doing so, the surveyor selecting unit 22 uses a machine learning algorithm for the matching algorithm. Then, the surveyor selecting unit 22 selects a surveyor suitable for the environmental survey request based on the result of the matching.

For example, the surveyor selecting unit 22 selects surveyors, i.e., selects candidate surveyors, each having an appropriate specialty and/or qualification based on the purpose of the environmental survey (e.g., water-quality survey) included in the environmental survey request. Further, the surveyor selecting unit 22 selects surveyors each of whom is in an appropriate geographical position based on the location of the environmental survey included in the environmental survey request (e.g., Lake Biwa). When doing so, the surveyor selecting unit 22 uses a natural language processing (NLP) technology. The surveyor selecting unit 22 extracts important keywords and phrases from the text of the environmental survey request, compares them with factors included in the surveyor data, and selects appropriate surveyors.

Next, the surveyor selecting unit 22 evaluates information about the years of experience, the number of past projects, the geographical position, and the performance rating of each of the selected surveyors. It is important to consider not only the skill such as the specialty and qualification of the surveyor, but also the experience and performance rating of the surveyor. This is because surveyors having experience in a successful project in a specific location or under a specific environmental condition are more likely to be suitable for a new project under a similar condition.

Lastly, the surveyor selecting unit 22 selects the optimal surveyor from among candidate surveyors based on the evaluation result. In the process, the surveyor selecting unit 22 uses a rule-based approach (e.g., simple string matching) or a more advanced recommendation algorithm using machine learning (such as a random forest, a support vector machine, and a neural network).

As described above, the surveyor selecting unit 22 compares the skill, experience, and performance rating of the surveyor with the requirements for the environmental survey request, and thereby can efficiently and accurately select the most appropriate surveyor for the requested environmental survey.

Note that when a plurality of surveyors are required for a specific environmental survey request, the surveyor selecting unit 22 may select a plurality of surveyors in an optimal combination by taking the balance of the entire team into consideration. In the above-described example embodiment, the surveyor selecting unit 22 uses a machine learning algorithm for the matching algorithm. However, the matching algorithm is not limited to the machine learning algorithm, and the surveyor selecting unit 22 may use a combinational optimization algorithm when selecting a plurality of surveyors in an optimal combination. The combinational optimization algorithm is a mathematical approach used to solve a problem of selecting an optimal result from limited resources.

In the combinational optimization algorithm, for example, integer linear programming (ILP: Integer Linear Programming) is used. As the integer linear programming, the surveyor selecting unit 22 creates a model in which factors such as the specialty, qualification, years of experience, number of past projects, geographical position, and performance rating of the surveyor are variables. Then, the surveyor selecting unit 22 calculates a value with which an objective function (e.g., selecting the most suitable surveyor for the environmental survey request) is maximized or minimized under a specific constraint condition (e.g., under a restriction of the purpose of the environmental survey included in the environmental survey request and a restriction of the location of the environmental survey). By doing so, the surveyor selecting unit 22 selects a team of a plurality of surveyors suitable for the environmental survey request.

Further, regarding the combinational optimization algorithm, a heuristic algorithm or a metaheuristic algorithm (e.g., a genetic algorithm or simulated annealing) may be used as an approach different from the integer linear programming. These algorithms are effective especially when the scale of problem is large or the search space of the solution is wide, and may provide a faster solution. Although these algorithms do not guarantee a perfect optimal solution, they can find a satisfactory solution within a practical time limit.

Further, in the combinational optimization algorithm, weights can be assigned to specific factors of the surveyor data. For example, in the combinational optimization algorithm, when the accuracy of a water-quality survey, which is the purpose of the environmental survey, is important among all the factors of the environmental survey request in the environmental survey, in order to give a priority to surveyors having a specialty in the water-quality analysis, an experience therein, and a high performance rating therein, large weights can be assigned to these factors.

The weighting process is typically performed in, i.e., incorporated into, the objective function of the problem. In the objective function, different factors of the surveyor data (e.g., factors such as the specialty and geographical position of the surveyor) are multiplied by respective weights, and by doing so it is attempted to maximize or minimize the sum total of these weighted factors. By increasing the weight of a specific factor(s), the influence of the factor(s) on the final choice of the solution can be increased. For example, by assigning a weight to the specialty in the water-quality analysis, a surveyor having this specialty is more likely to be selected from among the team of surveyors.

How to assign weights is closely related to the needs of the user who requests the environmental survey. When a user requesting an environmental survey is particularly interested in a specific type of survey (e.g., improving the accuracy of a water-quality survey), a high weight(s) can be assigned to a specialty(ies) or the like related thereto in the algorithm. In this way, it is possible to tailor the algorithm according to the needs of the user and provide more appropriate matching.

However, in order to appropriately carry out weighting, it is necessary to understand which factor has the largest influence on the success of the environmental survey. Therefore, weights may be dynamically set based on the analysis on past data and opinions of experts. For example, weights may be dynamically set based on law and regulations, and/or public information such as guidelines and IR information of other companies in the same industry as described below. For example, law and regulations, and guidelines for environmental surveys are drastically changed. In law and regulations, and guidelines, requirements for specific environmental factors and survey methods are specified, and there is a possibility that due to changes in them, the focus and methodology of environmental surveys may change. For example, in the case where because of a new environmental law, strict standards are set in regard to the protection of water resources, collection and analysis of data related to water resources become more important. With this in mind, regarding the algorithm, changes in law and regulations, and changes in guidelines are acquired, and weights are assigned based on the acquired information.

A natural language processing (NLP) technology is used to estimate weights of factors from public information. It is possible to extract statements and the like mentioning to specific environmental factors and research methods, and trends thereof from legal documents, industry reports, scientific research papers, and the like by using the NLP technology. For example, when a term “water resource” is frequently mentioned after a change in law or the like, this indicates that water resources have a high priority in the current environmental regulations. As a result, it is necessary to put an importance on factors in regard to water resources in the combinational optimization algorithm.

Analyses on past data and opinions of experts also play an important role in the weighting of important factors. Therefore, by analyzing past survey data, it is possible to analyze and calculate which environmental factors significantly contributed to the successes of the past surveys. Further, opinions and findings of experts provide insight into important factors because they reflect the latest scientific knowledge and the industry trends. Dynamically adjusting weighting in the algorithm based on such information is the key in order to flexibly respond to changes in reality and achieve more effective matching.

Next, in a step S103, the surveying means selecting unit 23 automatically selects surveying means (e.g., an apparatus and/or a tool) suitable for the environmental survey request from among the candidates thereof based on the surveying means data.

Specifically, the surveying means selecting unit 23 acquires the purpose and location of the environmental survey included in the environmental survey request. Further, the surveying means selecting unit 23 acquires data on environmental conditions such as geographical features, weather conditions, and ecosystem features at the location of the environmental survey. For example, the surveying means selecting unit 23 collects data on environmental conditions at the location of the environmental survey from satellite data, existing geographic information system (GIS) databases, and environmental databases.

Next, the surveying means selecting unit 23 automatically selects appropriate surveying means based on the acquired information. For example, when the purpose of the environmental survey request is to survey water quality, the surveying means selecting unit 23 selects a water-quality sensor and/or an environmental DNA sampling kit. When the environmental survey request is to survey the ecosystem in a forest, the surveying means selecting unit 23 selects remote sensing and/or a bio-logging device. In this process, the surveying means selecting unit 23 uses a complicated algorithm in which the purpose, location, and environmental conditions included in the environmental survey request, and the features of the surveying means included in the surveying means data are taken into consideration. The features of the surveying means include, for example, the appropriateness of the surveying means, the data collection accuracy of the surveying means, and the data collection range of the surveying means. This algorithm uses, for example, a rule-based system, knowledge of experts, and/or a machine learning model.

The surveying means is often used by itself, and is used for a specific purpose of the environmental survey, a specific location thereof, and specific environmental conditions thereof. The surveying means include a wide range of means from remote sensing to direct sampling. Examples of surveying means include a sensor for remote sensing using a satellite, a bio-logging device, an environmental DNA extraction kit, a drone, a soil sensor, a water-quality measurement kit, and an air-quality monitoring device.

The sensor for remote sensing using a satellite is a sensor used for remote sensing using a satellite that remotely observes, i.e., overserves from outer space, the surface of the earth. This sensor detects light having specific wavelengths and can efficiently collect data over a wide area. For example, regarding this sensor, satellite images are used to detect the influences of heat waves and/or deforestation. It is possible to monitor climate changes, the health of vegetation, and the state of the ocean by analyzing data collected by the above-described device.

The bio-logging device is a device used for bio-logging in which small recording devices are attached to wild animals and their movements and physiological conditions are monitored. The bio-logging device is, for example, a GPS tracker and/or an accelerometer, and can collect detailed data on activities of animals. It is possible to obtain, for example, behavior patterns of animals, uses of habitats, and migration routes by analyzing data collected by the above-described device.

The environmental DNA extraction kit extracts a DNA from a water or soil sample. The environmental DNA extraction kit is used to identify species living in an area of interest. It is possible to quickly and non-invasively assess the presence of a specific species and/or the level of biodiversity by analyzing the collected data. For example, it is possible to find the distribution of a specific type of fish by analyzing a DNA of that type of fish extracted from a water sample of a river.

The drone is used to take photographs of the surface of the earth and/or shooting videos thereof from the air, and thereby to observe the surface of the earth in detail. Further, the drone is also used to take a sample directly from the air. It is possible to survey geographical features and/or vegetation in an area that is difficult to access, and/or to assess the damage after a disaster by analyzing data collected from the drone.

The soil sensor is a sensor that is placed under the ground in order to measure the humidity, temperature, nutrient level, and the like of soil. This sensor is used for agriculture, monitoring for pollution in soil, assessment for the risk of landslide, and the like, and can provide real-time data.

The water-quality measurement kit measures the pH, amount of dissolved oxygen, concentration of harmful substances, and the like of water. It is possible to assess the state of the water quality of a river, a lake, or the ocean by analyzing the collected data.

The air-quality monitoring device is a specific sensor or an analytical instrument for precisely measuring physical parameters and/or chemical parameters in the environment. It is possible to measure the concentration of a pollutant in the air and thereby to monitor the air for air pollution by analyzing the collected data.

Next, in a step S104, the survey plan generation unit 24 generates an environmental surveying plan including a list of selected surveying means.

Specifically, the survey plan generation unit 24 generates an environmental surveying plan based on the environmental survey request. The environmental surveying plan includes a method for using each of the selected surveying means, a timing of data collection, a frequency of data collection, and data collection points; and a procedure for uploading the collected data and a procedure for analyzing the collected data. In this process, the survey plan generation unit 24 uses an operation research technology, especially multi-objective optimization and a time-series analysis. By doing so, the data collection efficiency in the environmental survey is maximized and the quality of collected data is guaranteed.

Next, in a step S105, the survey instruction unit 25 supplies a survey instruction including the list of selected surveying means and the generated environmental surveying plan to the surveyor terminal 102 of the selected surveyor.

Then, the surveyor collects data on the site based on the environmental surveying plan included in the survey instruction. Then, the surveyor uploads the collected data, i.e., environmental survey result data, to the environmental survey matching apparatus 20 by operating the surveyor terminal 102 or the surveying apparatus 103.

Next, in a step S106, the survey result receiving unit 26 receives the environmental survey result from at least one of the surveyor terminal 102 and the surveying apparatus 103.

Next, in a step S107, the survey result analysis unit 27 analyzes the environmental survey result. In this process, the survey result analysis unit 27 performs a data analysis process using artificial intelligence. For example, the survey result analysis unit 27 confirms the accuracy of the data, identifies patterns, and predicts changes in the environment.

Next, in a step S108, the analysis result showing unit 28 shows the analyzed result in the user terminal 101 from which the environmental survey request has issued. By doing so, the user can perform environmental management and/or make a policy decision based on the analysis result.

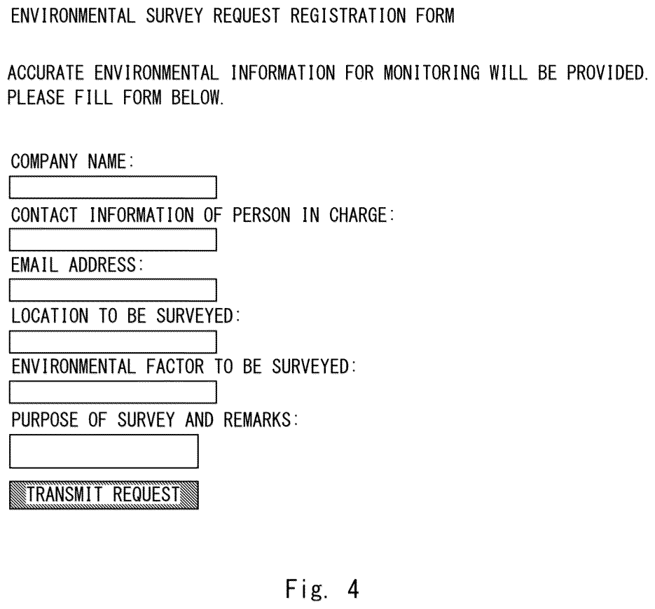

Next, a window for registering an environmental survey request displayed on the user terminal 101 of the environmental survey matching system 2 according to the second example embodiment will be described with reference to FIG. 4.

FIG. 4 shows an example of a window for registering an environmental survey request displayed on the user terminal 101 of the environmental survey matching system 2 according to this example embodiment.

The registration window shown in FIG. 4 is a form for registering details of an environmental survey request. In the registration window, the purpose of the form and how to use the form are briefly explained, so that it is clarified what kind of information is required from the user. Further, this form also includes fields in which the user enters a company name, contact information of a person in charge, an email address, a location to be surveyed, an environmental factor to be surveyed, the purpose of the survey, and remarks. Each field is clearly labeled and designed so that a user can easily enter necessary information. Further, a button for transmitting entered information is provided, so that a user can complete the form and submit the environmental survey request to the environmental survey matching apparatus 20. Then, the environmental survey matching apparatus 20 registers the submitted environmental survey request in the storage unit 29.

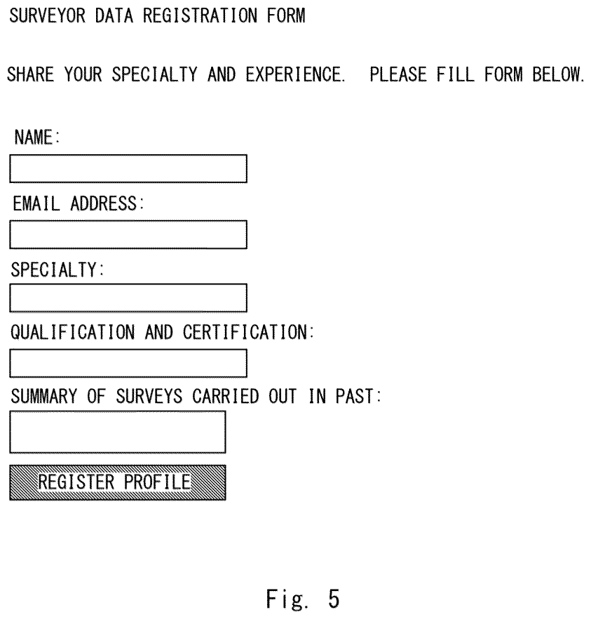

Next, a window for registering surveyor data displayed on the surveyor terminal 102 of the environmental survey matching system 2 according to the second example embodiment will be described with reference to FIG. 5.

FIG. 5 shows an example of a window for registering surveyor data displayed on the surveyor terminal 102 of the environmental survey matching system 2 according to this example embodiment.

The registration window shown in FIG. 5 is a form by which a professional surveyor enters and share, i.e., let other surveyors and the like know, his/her own data. At the top of the window, there is a clearly-described title and a brief description to explain what the user needs to do. The form includes fields for entering a name, an email address, a specialty, a qualification and certification, and a summary of surveys he/she carried out in the past. Each field is clearly labeled and designed so that a user can easily and accurately enter his/her own data. This window has a simple and intuitive design so that a surveyor can effectively share, i.e., let other surveyors and the like know, his/her skill, experience, and performance rating. In the window, a button for transmitting entered information is provided, so that a surveyor can complete the form and submit surveyor data to the environmental survey matching apparatus 20. Then, the environmental survey matching apparatus 20 registers the submitted surveyor data in the storage unit 29.

The environmental survey matching system 2 according to the second example embodiment automatically selects a surveyor and surveying means suitable for an environmental survey request, and analyzes an environmental survey result. Therefore, the environmental survey matching system 2 can quickly and efficiently collect environmental survey results, and analyze the collected environmental survey results.

Further, in the environmental survey matching system 2, the choices of a surveyor and surveying means suitable for an environmental survey request, and the analysis of an environmental survey result are automated as a flow of a series of processes. Therefore, the environmental survey matching system 2 can reduce human errors and provide consistent and high-quality data.

### <Hardware Configuration>

An entity or the like that performs each process described in the above-described example embodiments is arbitrarily determined and is not limited to the above-described examples. That is, it is possible to implement the function of each apparatus of the environmental survey matching apparatus 10 and the environmental survey matching system 2 (such as the environmental survey matching apparatus 20) by a plurality of apparatuses (which can also be referred to as processors) capable of communicating with each other. For example, each of the processes shown in the flowchart shown in FIG. 3 can be performed by a plurality of processors in a shared manner. That is, an entity or the like that performs an optimization support method in the above-described example embodiments may be one processor or a plurality of processors.

Some or all of the functions of the apparatuses of the environmental survey matching apparatus 10 and the environmental survey matching system 2 may be implemented by hardware such as an integrated circuit (IC chip) or by software.

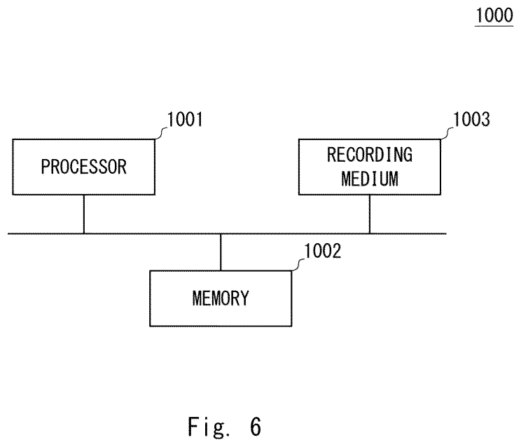

In the latter case, each of the apparatuses of the environmental survey matching apparatus 10 and the environmental survey matching system 2 may be implemented by, for example, a computer that executes instructions of a program that is software for implementing each function. An example of such a computer (hereinafter referred to as a computer 1000) is shown in FIG. 6. FIG. 6 is a block diagram showing the hardware configuration of the computer 1000 according to an example embodiment of the present disclosure.

The computer 1000 includes at least one processor 1001 and at least one memory 1002. In the memory 1002, a program for operating the computer 1000 as each apparatus of the environmental survey matching apparatus 10 and the environmental survey matching system 2 is recorded. In the computer 1000, the processor 1001 loads and executes the program from the memory 1002, and thereby implements the function of each apparatus of the environmental survey matching apparatus 10 and the environmental survey matching system 2.

As the processor 1001, for example, a CPU (Central Processing Unit), a GPU (Graphic Processing Unit), a DSP (Digital Signal Processor), an MPU (Micro Processing Unit), an FPU (Floating Point Number Processing Unit), a PPU (Physics Processing Unit), a TPU (Tensor Processing Unit), a quantum processor, a microcontroller, or a combination thereof can be used. As the memory 1002, for example, a flash memory, an HDD (Hard Disk Drive), an SSD (Solid State Drive), or a combination thereof can be used.

Note that the computer 1000 may further include a RAM (Random Access Memory) for unfolding the program and temporarily storing various data when executing the program. Further, the computer 1000 may further include a communication interface for transmitting and receiving data to and from other apparatuses. Further, the computer C may further include an input/output interface for connecting input/output devices such as a keyboard, a mouse, a display device, and a printer.

Further, the program can be recorded in a non-transitory tangible recording medium 1003 that can be read by the computer 1000. As such a recording medium 1003, for example, a tape, a disk, a card, a semiconductor memory, or a programmable logic circuit can be used. The computer 1000 may acquire the program through such recording medium 1003. Further, the program may be transmitted through a transmission medium. As such a transmission medium, for example, a communication network or a broadcast wave can be used. The computer 1000 can acquire the program through such transmission medium.

Further, the above-described function of each apparatus of the environmental survey matching apparatus 10 and the environmental survey matching system 2 may be implemented by a single processor provided in a single computer, by having a plurality of processors provided in a single computer cooperate with each other, or by having a plurality of processors provided in a plurality of respective computers cooperate with each other. Further, the program for implementing the above-described each function in a respective one of the apparatuses of the environmental survey matching apparatus 10 and the environmental survey matching system 2 may be stored in a single memory provided in a single computer, stored in a plurality of memories provided in a single computer in a distributed manner, or stored in a plurality of memories provided in a plurality of respective computers in a distributed manner.

While the disclosure has been particularly shown and described with reference to example embodiments thereof, the disclosure is not limited to these example embodiments. It will be understood by those of ordinary skill in the art that various changes in form and details may be made therein without departing from the spirit and scope of the present disclosure as defined by the claims.

The whole or part of the example embodiments disclosed above can be described as, but not limited to, the following supplementary notes.

### (Supplementary Note 1)

An environmental survey matching apparatus comprising:
a survey request receiving unit configured to receive an environmental survey request from a user;
a surveyor selecting unit configured to select a surveyor suitable for the environmental survey request based on a result of matching between a factor included in the environmental survey request and a factor included in data on a surveyor stored in advance;
a surveying means selecting unit configured to select surveying means including at least one of an apparatus and a tool suitable for the environmental survey request; and
a survey instruction unit configured to supply a survey instruction including a list of the selected surveying means to the selected surveyor.

### (Supplementary Note 2)

The environmental survey matching apparatus described in Supplementary note 1, wherein
the environmental survey request includes a purpose of the environmental survey and a location of the environmental survey,
the data on the surveyor includes a skill of the surveyor and a geographical position of the surveyor, and
the surveyor selecting unit selects a surveyor suitable for the environmental survey request based on a result of matching between the purpose of the environmental survey with the skill of the surveyor, and a result of matching between the location of the environmental survey with the geographical position of the surveyor.

### (Supplementary Note 3)

The environmental survey matching apparatus described in Supplementary note 2, wherein
the data on the surveyor includes at least one of an experience of the surveyor and a performance rating of the surveyor, and
the surveyor selecting unit selects a surveyor suitable for the environmental survey request by taking at least one of the experience of the surveyor and the performance rating of the surveyor into consideration.

### (Supplementary Note 4)

The environmental survey matching apparatus described in Supplementary note 1, wherein the surveyor selecting unit calculates importance of each of the factors included in the environmental survey request based on disclosed information, and dynamically changes weighting in the matching based on the calculated importance.

### (Supplementary Note 5)

The environmental survey matching apparatus described in Supplementary note 1, further comprising a survey plan generation unit configured to generate an environmental surveying plan, the environmental surveying plan being a plan of an environmental survey that the selected surveyor will carry out based on the environmental survey request, wherein
the survey instruction unit supplies a survey instruction including the list of selected surveying means and the generated environmental surveying plan to the selected surveyor.

### (Supplementary Note 6)

The environmental survey matching apparatus described in Supplementary note 5, wherein the environmental surveying plan includes at least one of a method for using the selected surveying means, a timing of data collection, a frequency of data collection, a data collection point, and a procedure for uploading collected data.

### (Supplementary Note 7)

The environmental survey matching apparatus described in Supplementary note 1, further comprising:
a survey result receiving unit configured to receive an environmental survey result from the surveyor after the survey instruction is supplied to the surveyor;
a survey result analysis unit configured to analyze the received environmental survey result; and
an analysis result showing unit configured to show the analyzed result to the user.

### (Supplementary Note 8)

The environmental survey matching apparatus described in Supplementary note 1, wherein the surveyor selecting unit uses at least one of a machine learning algorithm and a combinational optimization algorithm in the matching.

### (Supplementary Note 9)

An environmental survey matching method, wherein a computer:
receives an environmental survey request from a user;
selects a surveyor suitable for the environmental survey request based on a result of matching between a factor included in the environmental survey request and a factor included in data on a surveyor stored in advance;
selects surveying means including at least one of an apparatus and a tool suitable for the environmental survey request; and
supplies a survey instruction including a list of the selected surveying means to the selected surveyor.

### (Supplementary Note 10)

The environmental survey matching method described in Supplementary note 9, wherein
the environmental survey request includes a purpose of the environmental survey and a location of the environmental survey,
the data on the surveyor includes a skill of the surveyor and a geographical position of the surveyor, and
the computer selects a surveyor suitable for the environmental survey request based on a result of matching between the purpose of the environmental survey with the skill of the surveyor, and a result of matching between the location of the environmental survey with the geographical position of the surveyor.

### (Supplementary Note 11)

The environmental survey matching method described in Supplementary note 10, wherein
the data on the surveyor includes at least one of an experience of the surveyor and a performance rating of the surveyor, and
the computer selects a surveyor suitable for the environmental survey request by taking at least one of the experience of the surveyor and the performance rating of the surveyor into consideration.

### (Supplementary Note 12)

The environmental survey matching method described in Supplementary note 9, wherein the computer calculates importance of each of the factors included in the environmental survey request based on disclosed information, and dynamically changes weighting in the matching based on the calculated importance.

### (Supplementary Note 13)

The environmental survey matching method described in Supplementary note 9, wherein the computer:
generates an environmental surveying plan, the environmental surveying plan being a plan of an environmental survey that the selected surveyor will carry out based on the environmental survey request; and
supplies a survey instruction including the list of selected surveying means and the generated environmental surveying plan to the selected surveyor.

### (Supplementary Note 14)

The environmental survey matching method described in Supplementary note 13, wherein the environmental surveying plan includes at least one of a method for using the selected surveying means, a timing of data collection, a frequency of data collection, a data collection point, and a procedure for uploading collected data.

### (Supplementary Note 15)

The environmental survey matching method described in Supplementary note 9, wherein the computer:
receives an environmental survey result from the surveyor after the survey instruction is supplied to the surveyor,
analyzes the received environmental survey result; and
shows the analyzed result to the user.

### (Supplementary Note 16)

The environmental survey matching method described in Supplementary note 9, wherein the computer uses at least one of a machine learning algorithm and a combinational optimization algorithm in the matching.

### (Supplementary Note 17)

A program for causing a computer to perform processes including:
receiving an environmental survey request from a user;
selecting a surveyor suitable for the environmental survey request based on a result of matching between a factor included in the environmental survey request and a factor included in data on a surveyor stored in advance;
selecting surveying means including at least one of an apparatus and a tool suitable for the environmental survey request; and
supplying a survey instruction including a list of the selected surveying means to the selected surveyor.

### (Supplementary Note 18)

The program described in Supplementary note 17, wherein
the environmental survey request includes a purpose of the environmental survey and a location of the environmental survey,
the data on the surveyor includes a skill of the surveyor and a geographical position of the surveyor, and
the program causes the computer to perform a process for selecting a surveyor suitable for the environmental survey request based on a result of matching between the purpose of the environmental survey with the skill of the surveyor, and a result of matching between the location of the environmental survey with the geographical position of the surveyor.

### (Supplementary Note 19)

The program described in Supplementary note 18, wherein
the data on the surveyor includes at least one of an experience of the surveyor and a performance rating of the surveyor, and
the program causes the computer to perform a process for selecting a surveyor suitable for the environmental survey request by taking at least one of the experience of the surveyor and the performance rating of the surveyor into consideration.

### (Supplementary Note 20)

The program described in Supplementary note 17, wherein the program causes the computer to perform a process for calculating importance of each of the factors included in the environmental survey request based on disclosed information, and dynamically changing weighting in the matching based on the calculated importance.

### (Supplementary Note 21)

The program described in Supplementary note 17, wherein the program causes the computer to perform processes including:
generating an environmental surveying plan, the environmental surveying plan being a plan of an environmental survey that the selected surveyor will carry out based on the environmental survey request; and
supplying a survey instruction including the list of selected surveying means and the generated environmental surveying plan to the selected surveyor.

### (Supplementary Note 22)

The program described in Supplementary note 21, wherein the environmental surveying plan includes at least one of a method for using the selected surveying means, a timing of data collection, a frequency of data collection, a data collection point, and a procedure for uploading collected data.

### (Supplementary Note 23)

The program described in Supplementary note 17, wherein the program causes the computer to perform processes including:
receiving an environmental survey result from the surveyor after the survey instruction is supplied to the surveyor,
analyzing the received environmental survey result; and
showing the analyzed result to the user.

### (Supplementary Note 24)

The program described in Supplementary note 17, wherein the program causes the computer to perform a process for using at least one of a machine learning algorithm and a combinational optimization algorithm in the matching.

According to the present disclosure, it is possible to provide an environmental survey matching apparatus, an environmental survey matching method, and a non-transitory computer readable medium capable of quickly and efficiently collecting environmental data.

What is claimed is:

1. An environmental survey matching apparatus comprising:
at least one memory storing instructions, and
at least one processor configured to execute the instructions to:
receive an environmental survey request from a user;
select a surveyor suitable for the environmental survey request based on a result of matching between a factor included in the environmental survey request and a factor included in data on a surveyor stored in advance;
select surveying means including at least one of an apparatus and a tool suitable for the environmental survey request; and
supply a survey instruction including a list of the selected surveying means to the selected surveyor.

2. The environmental survey matching apparatus according to claim 1, wherein
the environmental survey request includes a purpose of the environmental survey and a location of the environmental survey,
the data on the surveyor includes a skill of the surveyor and a geographical position of the surveyor, and
the at least one processor is further configured to execute the instructions to select a surveyor suitable for the environmental survey request based on a result of matching between the purpose of the environmental survey with the skill of the surveyor, and a result of matching between the location of the environmental survey with the geographical position of the surveyor.

3. The environmental survey matching apparatus according to claim 2, wherein
the data on the surveyor includes at least one of an experience of the surveyor and a performance rating of the surveyor, and
the at least one processor is further configured to execute the instructions to select a surveyor suitable for the environmental survey request by taking at least one of the experience of the surveyor and the performance rating of the surveyor into consideration.

4. The environmental survey matching apparatus according to claim 1, wherein the at least one processor is further configured to execute the instructions to calculate importance of each of the factors included in the environmental survey request based on disclosed information, and dynamically change weighting in the matching based on the calculated importance.

5. The environmental survey matching apparatus according to claim 1, wherein the at least one processor is further configured to execute the instructions to:
generate an environmental surveying plan, the environmental surveying plan being a plan of an environmental survey that the selected surveyor will carry out based on the environmental survey request;
supply a survey instruction including the list of selected surveying means and the generated environmental surveying plan to the selected surveyor.

6. The environmental survey matching apparatus according to claim 5, wherein the environmental surveying plan includes at least one of a method for using the selected surveying means, a timing of data collection, a frequency of data collection, a data collection point, and a procedure for uploading collected data.

7. The environmental survey matching apparatus according to claim 1, wherein the at least one processor is further configured to execute the instructions to:
receive an environmental survey result from the surveyor after the survey instruction is supplied to the surveyor;
analyze the received environmental survey result; and
show the analyzed result to the user.

8. The environmental survey matching apparatus according to claim 1, wherein the at least one processor is further configured to execute the instructions to use at least one of a machine learning algorithm and a combinational optimization algorithm in the matching.

9. An environmental survey matching method, wherein a computer:
receives an environmental survey request from a user;
selects a surveyor suitable for the environmental survey request based on a result of matching between a factor included in the environmental survey request and a factor included in data on a surveyor stored in advance;
selects surveying means including at least one of an apparatus and a tool suitable for the environmental survey request; and
supplies a survey instruction including a list of the selected surveying means to the selected surveyor.

10. A non-transitory computer readable medium storing a program for causing a computer to perform processes including:
receiving an environmental survey request from a user;
selecting a surveyor suitable for the environmental survey request based on a result of matching between a factor included in the environmental survey request and a factor included in data on a surveyor stored in advance;
selecting surveying means including at least one of an apparatus and a tool suitable for the environmental survey request; and
supplying a survey instruction including a list of the selected surveying means to the selected surveyor.
